(19) United States
(12) Patent Application Publication
(10) Pub. No.: US 2009/0255420 A1
(43) Pub. Date: Oct. 15, 2009

(54) PASTRY CRUST EDGE COVER

(76) Inventors: ROBIN FREEMAN, Basin City, WA (US); Troy Freeman, Basin City, WA (US)

Correspondence Address: James Ray & Associates, 2640 Pitcairn Road, Monroeville, PA, 15146, US

(21) Appl. No.: 12/405,605

(22) Filed: Mar. 17, 2009

Related U.S. Application Data
(60) Provisional application No. 61/044,926, filed on Apr. 15, 2008.

(51) Int. Cl. A47J 43/00

(52) U.S. Cl. 99/645

(57) ABSTRACT

A pastry crust edge cover includes a cover member manufactured from a first predetermined material and having a first predetermined shape and a first predetermined size. Such cover member includes at least a first outer wall having a first end and a second end, and a top crust covering portion having a first end and a second end, such first end of such first outer wall being connected to such first end of such top crust covering portion such that such top crust covering portion extends substantially perpendicularly from such first outer wall.

### CROSS REFERENCE TO RELATED APPLICATION

This patent application is related to and claims priority from U.S. Provisional Patent Application Ser. No. 61/044,926 filed Apr. 15, 2008.

### FIELD OF THE INVENTION

The present invention relates, in general, to bakeware and, more particularly, this invention relates to a device for covering and/or wrapping around edges of a pastry crust to prevent such edges from being over cooked.

### BACKGROUND OF THE INVENTION

Prior to the conception and development of the present invention, baking pans and pie pans, such as glass, metal, and aluminum foil pans, as are generally well known in the prior art, have been used for baking pies and pastries. Unfortunately, the edges of such pies and pastries often cook faster than the middle. The edges may therefore become dry, overcooked, crumbly, and over brown or burnt, thereby detracting from taste, appearance, and ease of serving of such pies and pastries.

### SUMMARY OF THE INVENTION

The present invention provides a pastry crust edge cover which includes a cover member manufactured from a first predetermined material and having a first predetermined shape and a first predetermined size. Such cover member includes at least a first outer wall having a first end and a second end, and a top crust covering portion having a first end and a second end, such first end of such first outer wall being connected to such first end of such top crust covering portion such that such top crust covering portion extends substantially perpendicularly from such first outer wall.

### OBJECTS OF THE INVENTION

It is, therefore, one of the primary objects of the present invention to provide a flexible device for placement over the edges of a pie as it is baking such that such edges will not burn or become overly brown.

Another object of the present invention is to provide a device which can be placed over the edges of a pastry crust in a round pan for preventing over cooking of such pastry crust and such device being flexible such that it may be coiled for storage.

Still another object of the present invention is to provide a elongated device having a channel formed therein for placement over the edges of a pastry crust within a baking pan to prevent too much browning of such pastry crust while such pastry crust is cooked.

Yet another object of the present invention is to provide a pliable device which can be placed upon and wrapped over the edges of pie and pastry crusts to prevent over browning and burning of such pie and pastry crusts and such device being easy removable from such crusts after use without marking or damaging such crusts.

An additional object of the present invention is to provide a silicone pie crust wrap for protecting edges of a pie crust from over browning and burning while such pie crust is baking, such device including a lip member for preventing such device from slipping off such pie crust during baking.

It is still an additional object of the present invention to provide a device which can be wrapped around at least one of edges of a pastry crust, edges of a predetermined pan, and a combination thereof such that such pastry crust edges are housed within a channel and will not become over cooked during baking.

Still another object of the present invention is to provide a pastry crust edge wrap which can be used to wrap around edges of a pastry crust to prevent such pastry crust edges from overbaking; such device being open ended and capable of being overlapped upon itself such that pastry crusts of various sizes can be accommodated.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention in which the invention is poised to be placed over the edges of a pie crust.

FIG. 2 is a partial perspective view of the invention according to one embodiment of the invention in which the device has been implemented on a pie; the device may be overlapped upon itself to fit different sized pastries and pans.

FIG. 3 is a partial perspective view of the invention according to one embodiment of the invention evidencing that the invention may be stretched out in an elongated line as well as curved.

FIG. 4 is a partial perspective view of the invention according to one embodiment of the invention in which the invention is illustrated in a coiled position.

FIG. 5 is an exploded cutaway view of an end of the invention according to one embodiment of the invention; FIG. 5 illustrates the channel formed for receiving at least one of edges of a pastry crust, edges of a predetermined baking dish, and a combination thereof therein.

FIG. 6 is a partial perspective view of the invention according to one embodiment of the invention.

FIG. 7 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

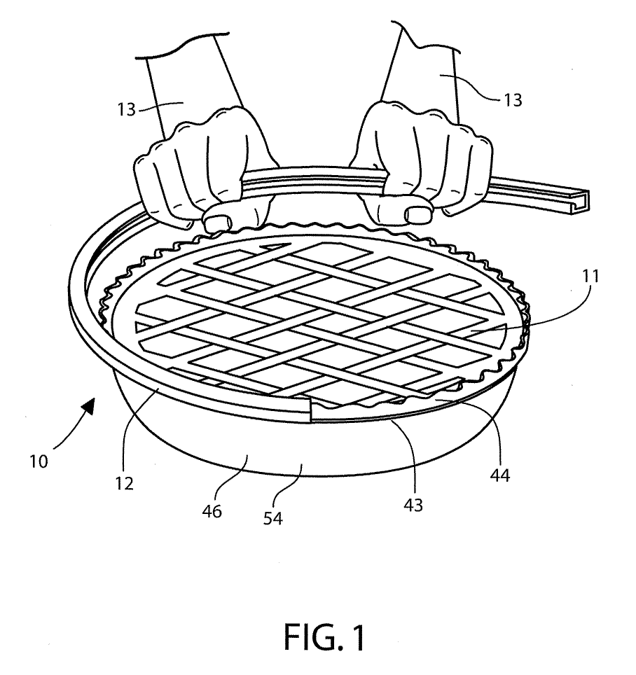

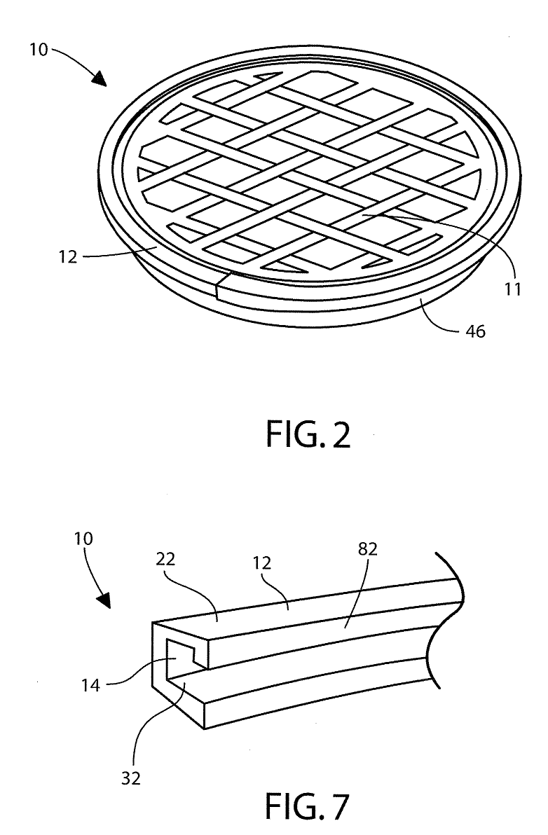

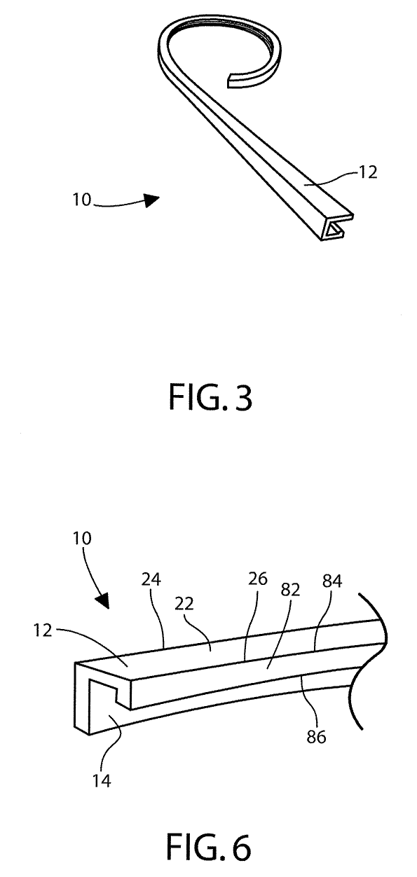

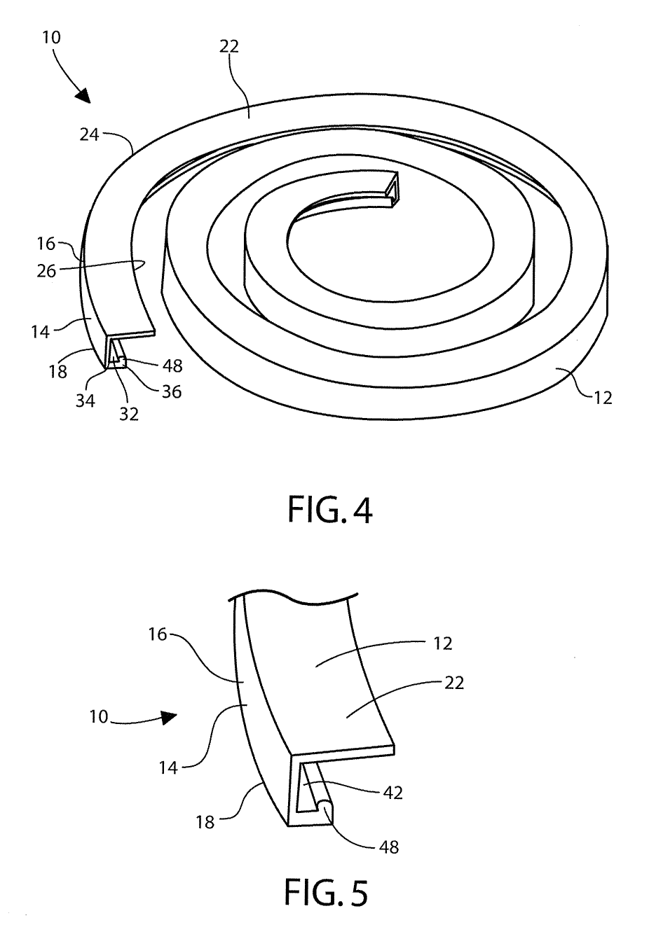

Reference is now made, more particularly, to FIGS. 1-7.

Referring more specifically to FIGS. 1-5, a pastry crust edge cover, generally designated 10, includes a cover member 12 manufactured from a first predetermined material and having a first predetermined shape and a first predetermined size. It is presently preferred that such first predetermined material is at least one of rubber, plastic, metal, and a combination thereof. It is presently most preferred that such first predetermined material is rubber, preferably silicone. It is also presently preferred that such first predetermined material is heat resistant.

Such cover member 12 includes at least a first outer wall 14 having a first end 16 and a second end 18, and a top crust covering portion 22 having a first end 24 and a second end 26, such first end 16 of such first outer wall 14 being connected to such first end 24 of such top crust covering portion 22 such that such top crust covering portion 22 extends substantially perpendicularly from such first outer wall 14.

It is presently preferred that such cover member 12 includes a second outer wall 32 having a first end 34 and a second end 36, such first end 34 of such second outer wall 32 being connected to such second end 18 of such first outer wall 14 such that such second outer wall 32 extends substantially perpendicularly therefrom substantially parallel to and opposite from such top crust covering portion 22 thereby forming a channel 42 for receiving at least one of edges 44 of such pastry crust 11, edges 43 of a predetermined baking dish 46, and a combination thereof therein.

It is further presently preferred that such cover member includes a lip member 48 disposed along such second outer wall 32 at such second end 36 thereof for releasably securing such cover member 12 to edges 43 of such predetermined baking dish 46, such predetermined baking dish 46 being preferably at least one of a pie pan, a torte pan, a springform pan, a cake pan, and a combination thereof. It is presently most preferred that such predetermined baking dish 46 is a pie pan 54.

It is presently preferred that such cover member 12 is elongated and open-ended.

It is further presently preferred that such cover member 12 curves and may be coiled.

It is also presently preferred that such cover member 12 is flexible.

It is presently preferred that such cover member 12 is between about 30 inches and about 38 inches long. It is further presently preferred that such top crust covering portion 22 of such cover member 12 is between about 1 inch and about 2 inches wide. Furthermore, such first outer wall 14 is preferably between about 1 inch and about 2 inches high and it is presently preferred that second outer wall 32 is between about 0.5 and about 2.0 inches in height.

It is meant that a user of such device wrap the cover member around at least one of such pastry crust edges, edges of a predetermined baking dish, and a combination thereof. Since the device is open ended, it may easily be overlapped upon itself to accommodate pastry crusts in baking dishes and pans of various sizes. The unique wrapping capability of the device enables such cover member to achieve a close fit to such pastry crust edges and substantially conform to the shape of at least one of such pastry crust edges, edges of such predetermined baking dish, and a combination thereof to optimally protect such pastry crust edges from overbaking.

According to another embodiment, as illustrated in FIG. 6 such cover member 12 includes an inner wall member 82 having a first end 84 and a second end 86, such first end 82 of such inner wall member 82 being connected to such second end 26 of such top crust covering portion 22 such that such inner wall member 82 extends substantially perpendicularly therefrom substantially parallel and opposite from such first outer wall 14 thereby forming a channel for receiving at least one of edges of such pastry crust, edges of a predetermined baking dish, and a combination thereof.

According to yet another embodiment, as illustrated in FIG. 7, such cover member 12 may include both such second outer wall 32 and such inner wall member 82.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A pastry crust edge cover comprising a cover member manufactured from a first predetermined material and having a first predetermined shape and a first predetermined size, said cover member including at least a first outer wall having a first end and a second end, and a top crust covering portion having a first end and a second end, said first end of said first outer wall being connected to said first end of said top crust covering portion such that said top crust covering portion extends substantially perpendicularly from said first outer wall.

2. A pastry crust edge cover according to claim 1 wherein said cover member includes a second outer wall having a first end and a second end, said first end of said second outer wall being connected to said second end of said first outer wall such that said second outer wall extends substantially perpendicularly therefrom substantially parallel and opposite from said top crust covering portion thereby forming a channel for receiving at least one of edges of such pastry crust, edges of a predetermined baking dish, and a combination thereof therein.

3. A pastry crust edge cover according to claim 1 wherein said cover member further includes a lip member disposed along said second outer wall at said second end thereof for releasably securing said cover member to edges of a predetermined baking dish.

4. A pastry crust edge cover according to claim 3 wherein such predetermined baking dish is at least one of a pie pan, a torte pan, a springform pan, a cake pan, and a combination thereof.

5. A pastry crust edge cover according to claim 4 wherein such predetermined baking dish is a pie pan.

6. A pastry crust edge cover according to claim 1 wherein said cover member is elongated.

7. A pastry crust edge cover according to claim 6 wherein said cover member is open-ended.

8. A pastry crust edge cover according to claim 7 wherein said cover member curves.

9. A pastry crust edge cover according to claim 8 wherein said cover member may be coiled.

10. A pastry crust edge cover according to claim 1 wherein said cover member is flexible.

11. A pastry crust edge cover according to claim 1 wherein said first predetermined material is at least one of rubber, plastic, metal, and a combination thereof.

12. A pastry crust edge cover according to claim 11 wherein said first predetermined material is rubber.

13. A pastry crust edge cover according to claim 12 wherein said rubber is silicone.

14. A pastry crust edge cover according to claim 1 wherein said first predetermined material is heat resistant.

15. A pastry crust edge cover according to claim 1 wherein said cover member is between about 30 inches and about 38 inches long.

16. A pastry crust edge cover according to claim 1 wherein said top crust covering portion is between about 1 inch and about 2 inches wide.

17. A pastry crust edge cover according to claim 1 wherein said first outer wall is between about 1 inch and about 2 inches high.

18. A pastry crust edge cover according to claim 2 wherein said second outer wall is between about 0.5 and about 2.0 inches in height.

19. A pastry crust edge cover according to claim 1 wherein said pastry crust edge cover further includes an inner wall member having a first end and a second end, said first end of said inner wall member being connected to said second end of said top crust covering portion such that said inner wall extends substantially perpendicularly therefrom substantially parallel and opposite from said first outer wall thereby forming a channel for receiving at least one of edges of such pastry crust, edges of a predetermined baking dish, and a combination thereof.

20. A pastry crust edge cover according to claim 2 wherein said pastry crust edge cover further includes an inner wall member having a first end and a second end, said first end of said inner wall member being connected to said second end of said top crust covering portion such that said inner wall extends substantially perpendicularly therefrom substantially parallel and opposite from said first outer wall thereby forming a channel for receiving at least one of edges of such pastry crust, edges of a predetermined baking dish, and a combination thereof.
